(19) United States
(12) Patent Application Publication
(10) Pub. No.: US 2020/0235457 A1
(43) Pub. Date: Jul. 23, 2020

(54) FILTER AND COMMUNICATION SYSTEM INCLUDING THE FILTER

(71) Applicant: CommScope Italy S.r.l., Agrate Brianza (IT)

(72) Inventors: Fengwei Ju, Suzhou (CN); Andrea Manzoni, Missaglia (IT); Jiansong He, Suzhou (CN); Yangzhun Lv, Suzhou (CN); Yanming Zhu, Suzhou (CN); Fei Liu, Suzhou (CN); Qing Mi, Suzhou (CN)

(21) Appl. No.: 16/745,741

(22) Filed: Jan. 17, 2020

(30) Foreign Application Priority Data
Jan. 23, 2019 (CN) 201910061252.8

(51) Int. Cl. H01P 7/06; H01P 7/10; H01P 1/205

(52) U.S. Cl. CPC H01P 7/06; H01P 1/2053; H01P 7/10

(57) ABSTRACT

Filters include a housing having a top wall, a bottom wall and one or more side walls that define an internal cavity; a plurality of resonators that are mounted within the internal cavity with a first space provided between a pair of adjacent resonators; and a coupling-tuning element mounted on one of the walls of the housing. The coupling-tuning element comprises one or more solid dielectric materials and is capable of extending into the first space to tune the coupling characteristics between the pair of adjacent resonators.

### CROSS-REFERENCE TO RELATED APPLICATION

The present application claims priority to Chinese Patent Application Serial No. 201910061252.8, filed Jan. 23, 2019, the entire content of which is incorporated herein by reference.

### FIELD

The present invention relates generally to cellular communication systems and, more particularly, to filters that are suitable for use in cellular communication systems. In addition, the present invention also relates to cellular communication systems including the filters.

### BACKGROUND

In cellular communication base stations, filters are used as frequency selection devices for passing radio frequency (RF) signals in certain frequency ranges while filtering out RF signals and/or noise in other frequency ranges. A wide variety of filters are currently used in cellular communication base stations, including microstrip filters, interdigital filters, coaxial cavity filters, waveguide filters, comb-line cavity filters, spiral cavity filters, small lumped parameter filters, ceramic dielectric filters, SIR filters and the like.

As coaxial cavity filters are suitable for mass production and are relatively low in cost, they are often used in cellular communication base stations. Tuning screws are typically movably mounted within one or more walls of the coaxial cavity filter, and the tuning screws are used to tune the frequency characteristics of the resonators mounted inside the filter after the coaxial cavity filter is manufactured.

### SUMMARY

According to a first aspect of the present invention, a filter is provided. The filter device comprises a housing having a top wall, a bottom wall and one or more side walls that define an internal cavity; a plurality of resonators that are mounted within the internal cavity with a first space provided between a pair of adjacent resonators; and a coupling-tuning element mounted on one of the walls of the housing, characterized in that the coupling-tuning element comprises one or more solid dielectric materials and is capable of extending into the first space to tune the coupling characteristics between the pair of adjacent resonators.

The filter device according to the present invention is advantageous. First, the coupling-tuning element made of solid dielectric materials may not generate an electric arc, thereby improving the reliability of the filter device. Second, the coupling-tuning element has significantly reduced effect on frequency characteristics of the resonators. Third, the coupling-tuning element is particularly suitable for use in compact filter devices, which widens the adjustable range and provides more tuning possibilities. Fourth, the requirements for manufacturing precision are lowered, and manufacturing costs are reduced.

In some embodiments, a resonance-tuning element is further mounted on one of the walls of the housing and configured to tune the frequency characteristics of a respective resonator.

In some embodiments, the first space includes: a gap between the two resonators of the pair of adjacent resonators; and/or a region above or below the gap; and/or a region in front of or behind the gap.

In some embodiments, the coupling-tuning element includes a rod that is made of a polymeric compound or a ceramic.

In some embodiments, the coupling-tuning element includes a rod that is made of polyetheretherketone.

In some embodiments, the resonance-tuning element includes a rod that is made of metal.

In some embodiments, the coupling-tuning element is configured as a tuning rod.

In some embodiments, the coupling-tuning element is provided with a metal self-locking head that is configured to be secured within a mounting hole in one of the walls in a self-locking manner.

In some embodiments, each of the resonators has a first end and a second end opposite thereto, the first end of each resonator is electrically and mechanically connected to a first wall of the housing, and the resonator extends from the first wall toward the second wall opposite the first wall, wherein a second space is present between an end surface of the second end of the resonator and a second wall, and the resonance-tuning element is configured to be movably extended into the second space.

In some embodiments, a dielectric module having a tuning channel is disposed in the first space, and the coupling-tuning element is configured to be movably inserted into the tuning channel.

In some embodiments, the extension range of the resonance-tuning element is less than a distance between the second wall and a plane where the end surface of the second end of the resonator is located.

In some embodiments, the extension range of the coupling-tuning element exceeds a distance between the second wall and a plane where the end surface of the second end of the resonator is located.

In some embodiments, the extension range of the coupling-tuning element is greater than that of the resonance-tuning element.

In some embodiments, the extension range of the coupling-tuning element is greater than 1.5, 2, 2.5, 3, 4, or 5 times the extension range of the resonance-tuning element.

In some embodiments, the resonator is constructed as a resonant column.

In some embodiments, the resonators extend substantially parallel to each other within the internal cavity.

In some embodiments, at least one coupling segment is formed between two adjacent resonators.

In some embodiments, each resonator is equivalent to a quarter-wavelength open-ended transmission line, or equivalent to a half-wavelength open-ended transmission line.

In some embodiments, the filter is configured as a multiplexer or combiner in the form of a multi-port resonant cavity filter.

In some embodiments, a plurality of connection ports are provided in the housing that are configured to receive and/or transmit signals.

In some embodiments, the top wall and the side walls are integrally formed, and/or the bottom wall and the side walls are integrally formed.

According to a second aspect of the present invention, a filter device is provided. The filter device has a housing defining an internal cavity, characterized in that a plurality of resonators are mounted within the internal cavity, a first space is provided between two adjacent resonators, and a coupling-tuning element is mounted in the filter, wherein the coupling-tuning element comprises one or more solid dielectric materials and is capable of extending into the first space to tune the coupling characteristics between the two adjacent resonators.

In some embodiments, a resonance-tuning element is further mounted in the filter so as to tune the frequency characteristics of a corresponding resonator.

In some embodiments, the first space includes: a gap between the two resonators of the pair of adjacent resonators; and/or a region above or below the gap; and/or a region in front of or behind the gap.

In some embodiments, the coupling-tuning element includes a rod that is made of a polymeric compound or a ceramic.

In some embodiments, the coupling-tuning element includes a rod that is made of polyetheretherketone.

In some embodiments, the resonance-tuning element includes a rod that is made of metal.

In some embodiments, the coupling-tuning element is configured as a tuning rod.

In some embodiments, the coupling-tuning element is provided with a metal self-locking head that is configured to be secured within a mounting hole in the filter in a self-locking manner.

In some embodiments, each of the resonators has a first end and a second end opposite thereto, the first end of the resonator is electrically and mechanically connected to the housing of the filter, and the second end of the resonator is spaced apart from the housing of the filter by a second space, wherein the resonance-tuning element is capable of extending into the second space.

In some embodiments, a dielectric module is disposed in the first space, a tuning channel is disposed in the dielectric module, and the coupling-tuning element is capable of extending into the tuning channel.

In some embodiments, the extension range of the resonance-tuning element is less than a distance between the second wall and a plane where the end surface of the second end of the resonator is located.

In some embodiments, the extension range of the coupling-tuning element exceeds a distance between the second wall and a plane where the end surface of the second end of the resonator is located.

In some embodiments, the extension range of the coupling-tuning element is greater than that of the resonance-tuning element.

In some embodiments, the extension range of the coupling-tuning element is greater than 2 times the extension range of the resonance-tuning element.

In some embodiments, the resonator is constructed as a resonant column.

In some embodiments, the resonators extend substantially parallel to each other within the internal cavity.

In some embodiments, one or more coupling segments are formed between the two adjacent resonators.

In some embodiments, each resonator is equivalent to a quarter-wavelength open-ended transmission line, or equivalent to a half-wavelength open-ended transmission line.

In some embodiments, the filter is configured as a multiplexer or combiner in the form of a multi-port resonant cavity filter.

In some embodiments, a plurality of connection ports are provided on the filter to receive and/or transmit signals.

According to a third aspect of the present invention, there is provided a communication system, characterized in that the communication system comprises a filter device according to the present invention.

### BRIEF DESCRIPTION OF THE DRAWINGS

FIG. 1 is a schematic view of a communication system with a filter according to embodiments of the present invention.

FIG. 2 is a schematic view of the filter of FIG. 1 with the top wall removed therefrom.

FIG. 3 is a perspective view of the filter of FIGS. 1 and 2 with the top wall removed therefrom.

FIG. 4 is a perspective view of a coupling-tuning element according to embodiments of the present invention.

FIG. 5 is a graph illustrating the coupling between two adjacent resonators as a function of the extension depth of a coupling-tuning element for (1) an all metal coupling-tuning element and (2) a coupling-tuning element according to embodiments of the present invention.

### DETAILED DESCRIPTION

Embodiments of the present invention will be described below with reference to the drawings, in which several embodiments of the present invention are shown. It should be understood, however, that the present invention may be implemented in many different ways, and is not limited to the example embodiments described below. In fact, the embodiments described hereinafter are intended to make a more complete disclosure of the present invention and to adequately explain the scope of the present invention to a person skilled in the art. It should also be understood that, the embodiments disclosed herein can be combined in various ways to provide many additional embodiments.

It should be understood that, the wording in the specification is only used for describing particular embodiments and is not intended to limit the present invention. All the terms used in the specification (including technical and scientific terms) have the meanings as normally understood by a person skilled in the art, unless otherwise defined. For the sake of conciseness and/or clarity, well-known functions or constructions may not be described in detail.

The singular forms “a/an” and “the” as used in the specification, unless clearly indicated, all contain the plural forms. The words “comprising”, “containing” and “including” used in the specification indicate the presence of the claimed features, but do not preclude the presence of one or more additional features. The wording “and/or” as used in the specification includes any and all combinations of one or more of the relevant items listed.

In the specification, words describing spatial relationships such as “up”, “down”, “left”, “right”, “forth”, “back”, “high”, “low” and the like may describe a relation of one feature to another feature in the drawings. It should be understood that these terms also encompass different orientations of the apparatus in use or operation, in addition to encompassing the orientations shown in the drawings. For example, when the apparatus in the drawings is turned over, the features previously described as being “below” other features may be described to be “above” other features at this time. The apparatus may also be otherwise oriented (rotated 90 degrees or at other orientations) and the relative spatial relationships will be correspondingly altered.

It should be understood that, in all the drawings, the same reference signs present the same elements. In the drawings, for the sake of clarity, the sizes of certain features may be modified.

Embodiments of the present invention will now be described in more detail with reference to the accompanying drawings, in which exemplary embodiments are described.

The tuning performance of the tuning screws used in conventional coaxial cavity filters may be limited. Conventional tuning screws have high tuning sensitivity, that is, each time the tuning screw is adjusted to move closer or farther away from an associated resonant column of the filter, the change in the resonant frequency is relatively large, so that over-tuning or under-tuning is apt to occur. In addition, due to the high tuning sensitivity of conventional tuning screws, the manufacturing precision of the coaxial cavity filter must be high, which increases the manufacturing cost and manufacturing difficulty of the coaxial cavity filter.

In addition, in many applications, it is desirable that the coaxial cavity filter be small in size in order to reduce weight, material costs, wind resistance and the like. However, as the size of a coaxial cavity filter is reduced, the space within the filter, including the space available for adjustable tuning screws to move along, may also be reduced. If a tuning screw comes too close to a metal resonant column, an electric arc may be generated that may damage the filter.

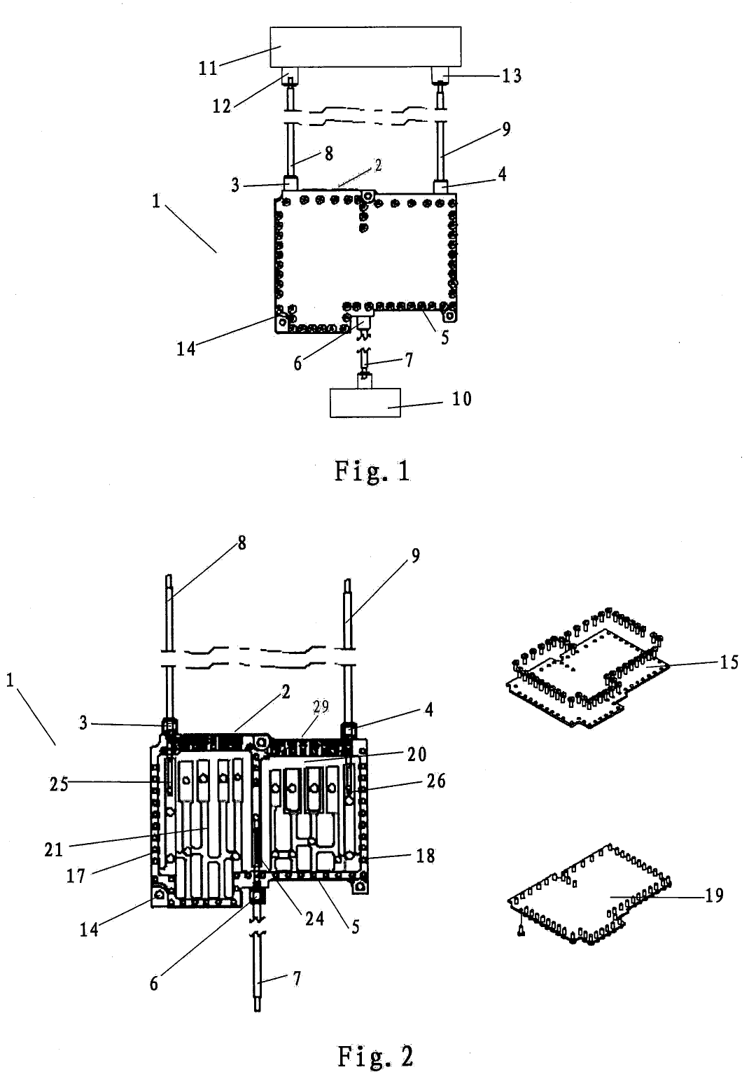

FIG. 1 is a schematic top view of a communication system that includes a filter according to an embodiment of the present invention. As shown in FIG. 1, the communication system includes a filter 1, which in the depicted example may be a bidirectional three-port duplexer. The filter 1 has a housing that comprises a top wall 15, a bottom wall 19 and a plurality of side walls (namely a rear wall 2, a front wall 5, a left wall 17 and a right wall 18). A first port 3 and a second port 4 extend from the rear wall 2, and a third port 6 extends from the front wall 5. The first port 3 may be connected to a transmitting port 12 of a communication device 11 (e.g., a radio) via a coaxial cable 8, the second port 4 may be connected to a receiving port 13 of the communication device 11 via a coaxial cable 9, and the third port 6 may be connected to a radiating element 10 of an antenna via a coaxial cable 7. The filter 1 can isolate an RF transmission path between the transmitting port 12 and the radiating element 10 from an RF transmission path between the receiving port 13 of the communication device 11 and the radiating element 10, while allowing for RF transmission between both the transmitting port 12 and the receiving port 13 and the radiating element 10 of the antenna.

In other embodiments, the filter 1 may include additional ports to implement multiplexers, triplexers, combiners or the like. The filter according to embodiments of the present invention may include, for example, four or more ports that are used to electrically connect the filter 1 to other external devices.

In the present embodiment, the first port 3, the second port 4 and the third port 6 each comprise a coaxial connector port that is configured to receive a coaxial cable. A center conductor of each of the coaxial cables 7, 8, 9 may be electrically connected to a respective resonator within the filter 1 by soldering, and an outer conductor of each of the coaxial cables 7, 8, 9 may be electrically connected to a housing 14 of the filter 1 by soldering, thereby achieving an RF signal transmission connection from the communication device 11 to the radiating element 10 via the filter 1, or vice versa.

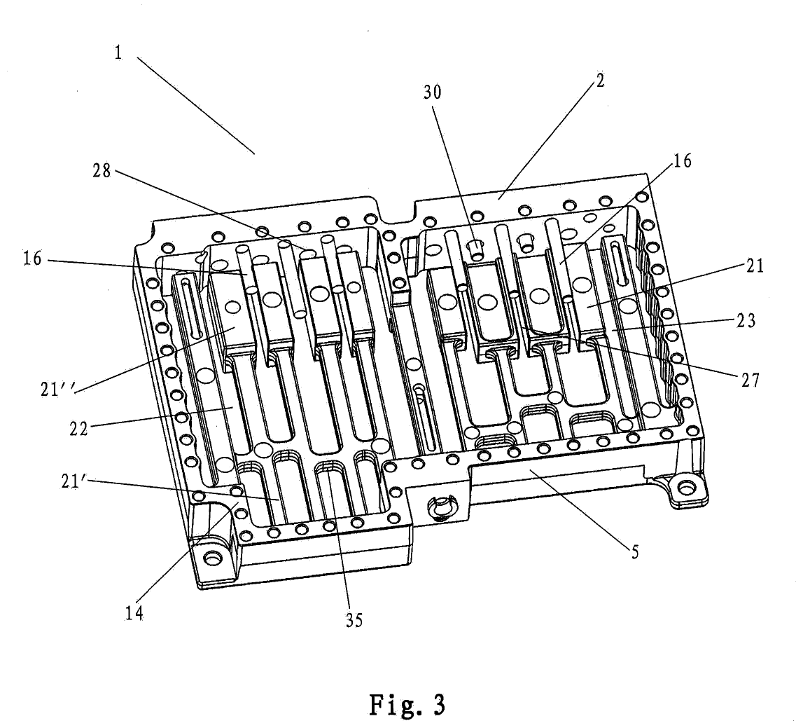

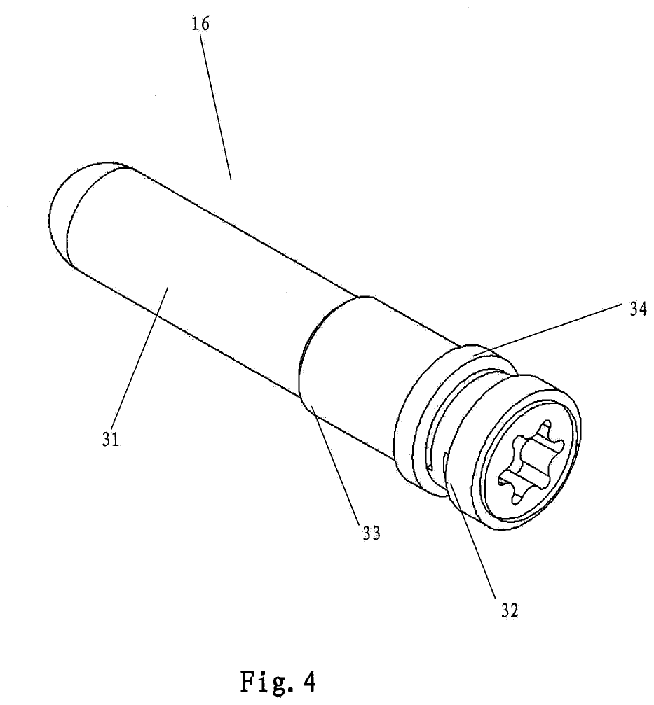

FIGS. 2-4 illustrate the filter 1 in accordance with embodiments of the present invention with a coupling-tuning element 16 and a resonance-tuning element 30 mounted therein. Specifically, FIG. 2 is a schematic view of the filter 1 with a top wall 15 removed therefrom; FIG. 3 is an enlarged perspective view of the filter 1 with the top wall 15 removed; and FIG. 4 is a perspective view of a coupling-tuning element 16 in accordance with an embodiment of the present invention that is included in the filter 1.

As shown in FIGS. 2-3, the filter 1 comprises a housing 14 that includes a top wall 15, a bottom wall 19 and four side walls (a rear wall 2, a front wall 5, a left wall 17, and a right wall 18, respectively). While the top wall 15 and the bottom wall 19 are shown in FIG. 2 as comprising separate pieces, it will be appreciated that at least one of the top wall 15 and the bottom wall 19 may be formed integrally with at least some of the side walls 2, 5, 17, 18 in other embodiments by, for example, die casting. A first port 3 and a second port 4 are provided on the rear wall 2, and a third port 6 is provided on the front wall 5. The walls define an internal cavity 20, in which a plurality of resonators 21 are disposed substantially parallel to each other. The internal cavity 20 is divided into a left chamber 22, in which a first subset of the resonators 21 are disposed, and a right chamber 23, in which a second subset of the resonators 21 are disposed. The resonator 21 in the region between the left chamber 22 and the right chamber 23 includes a receiving portion 24 for receiving the center conductor of the coaxial cable 7, thereby forming a bidirectional RF transmission path from the filter 1 to the radiating element 10. Further, in the left chamber 22, the resonator 21 on the left side includes a receiving portion 25 for receiving the center conductor of the coaxial cable 8, thereby forming an RF transmission path from the transmission port 12 of the communication device 11 to the filter 1. In the right chamber 23, the resonator 21 on the right side includes a receiving portion 26 for receiving the center conductor of the coaxial cable 9, thereby forming an RF transmission path from the filter 1 to the receiving port 13 of the communication device 11. Thus, an RF signal can be transmitted from the transmitting port 12 of the communication device 11 to the radiating element 10 via the coaxial cable 8, the left chamber 22 of the filter 1 and the coaxial cable 7. Likewise, an RF signal can also be transmitted from the radiating element 10 to the receiving port 13 of the communication device 11 via the coaxial cable 7, the right chamber 23 of the filter 1, and the coaxial cable 9.

As can be seen from FIGS. 2-3, the resonators 21 are constructed as resonant columns that are spaced apart from one another and extend in parallel with each other from the front wall 5 toward the rear wall 2. A first space 27 is formed between two adjacent resonators 21. Each of the resonators 21 has a first end 21′ and a second end 21″ opposite the first end 21′. The first end 21′ is electrically and mechanically connected to the front wall 5 of the housing 14, and extends from the front wall 5 toward the rear wall 2. An end surface of the second end 21″ of the resonator 21 is spaced apart from the rear wall 2, and there is a second space 28 between the end surface of the second end 21″ and the rear wall 2. In the present embodiment, each of the resonators 21 may be equivalent to a quarter-wavelength open-ended transmission line. It should be noted that the “first space 27” in the present disclosure refers to not only the gap between the two adjacent resonators 21 but also to the region above the gap up to the top wall 15 and to the region below the gap up to the bottom wall 19. The “second space 28” in the present disclosure includes not only the gap between the resonator 21 and the rear wall 2 but also the region above the gap up to the top wall 15 and the region below the gap up to the bottom wall 19.

As can be seen from FIGS. 2-3, the rear wall 2 of the filter 1 includes a plurality of mounting holes 29. A tuning element may be mounted in each of the mounting holes 29. A first subset of the mounting holes 29 are aligned with the respective resonators 21, and adjustable (e.g. movable) resonance-tuning elements 30 may be mounted in each of the mounting holes 29 in the first subset for tuning the frequency characteristics of the respective resonators 21. Each time one of the adjustable resonance-tuning elements 30 is moved either toward or away from its associated resonator 21, the inherent resonant frequency point of the resonator 21 may change accordingly. The remaining mounting holes 29 form a second subset of mounting holes 29 that are aligned with the respective first spaces 27 that are between adjacent resonators 21, and an adjustable (e.g. moveable) coupling-tuning element 16 may be mounted in each of the mounting holes 29 in the second subset of mounting holes 29 for tuning the coupling characteristics between the resonators 21. Each time a coupling-tuning element 16 is moved either toward (including into) or away from the first space 27, the degree of coupling between the resonators 21 that are adjacent the first space 27 may change accordingly.

In the present embodiment, the resonance-tuning element 30 is constructed as a metal tuning rod, such as an aluminum tuning rod, and the coupling-tuning element 16 is constructed as a rod made of a solid dielectric material such as polyetheretherketone (PEEK) having a relatively high dielectric constant. In other embodiments, the resonance-tuning element 30 and the coupling-tuning element 16 may also be constructed as an adjustment element of other materials (for example, other polymeric compound materials or ceramics) in other forms. Further, as can be seen from FIGS. 2-3, a coupling segment 35 may be provided between each pair of adjacent resonators 21 within a chamber 22, 23. Each coupling segment 35 may be integrally formed with the resonators 21 and may connect two adjacent resonators 21. The coupling segments 35 can improve the coupling performance between two adjacent resonators 21 in a predefined manner. The coupling-tuning element 16 can improve the coupling performance between the two adjacent resonators 21 in a tunable manner.

Referring now to FIG. 4, a perspective view of the coupling-tuning element 16 in accordance with embodiments of the present invention is shown. As shown in FIG. 4, a metal self-locking head 32 is provided at a first end of the coupling-tuning element 16. A receiving portion 33 is provided at an end of the metal self-locking head 32. A PEEK rod 31 (or other non-metal rod) may be inserted into the receiving portion 33 of the metal self-locking head 32 by compression molding and tightly connected with the metal self-locking head 32. The metal self-locking head acts as a shield that helps prevent RF energy from escaping outside the housing 14, thereby reducing energy loss and reducing the effect of the filter 1 on external devices. The resonance-tuning element 30 may also be similarly constructed with a metal self-locking head 32 having a PEEK rod inserted into a receiving portion thereof.

The metal self-locking head 32 may have an externally threaded portion 34 that is configured to be secured in the mounting hole 29 in a self-locking manner, which eliminates the need to provide a nut outside the walls to tighten the screw as in the prior art. Therefore, the filter 1 of the present invention not only saves space but also simplifies the installation process.

Further, as can be seen from FIG. 3, the coupling-tuning elements 16 in the filter 1 may have different extension lengths within the first space 27, and their materials, shapes (such as length, cross section) and other parameters can be designed by those skilled in the art based on simulation and experimental data to match a particular application.

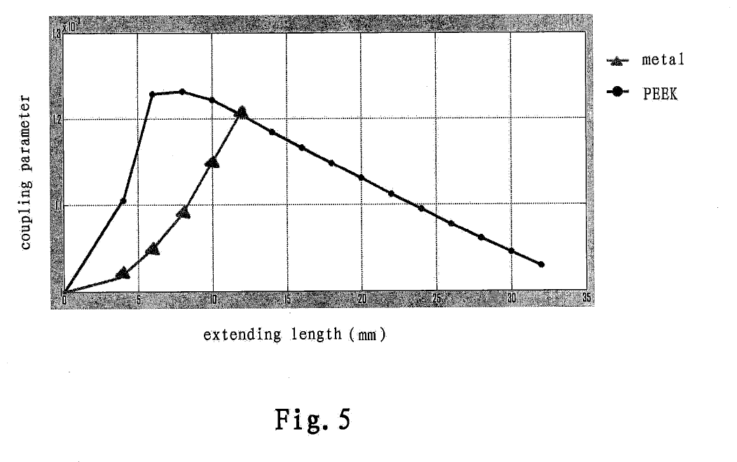

FIG. 5 is a graph illustrating the coupling between two adjacent resonators in a compact filter having the general design of filter 1 as a function of a depth to which a coupling-tuning element is inserted therebetween for (1) an all metal coupling-tuning element and (2) a coupling-tuning element 16 according to embodiments of the present invention.

In the graph of FIG. 5, the abscissa shows an extension length of the coupling-tuning element 16 from the rear wall 2 (here the length of the PEEK rod 31 in the receiving portion 33 is ignored), and the ordinate shows a coupling coefficient between the two adjacent resonators 21.

In the case of using the metal rod, the coupling coefficient monotonically increases as the coupling-tuning element is inserted further into the inner cavity of the filter. It can be seen from FIG. 5 that the metal rod has a high tuning sensitivity. In other words, the curve illustrating the coupling coefficient for the coupling-tuning element having a metal rod has a high slope, and each time the metal rod extends for a unit length, the coupling coefficient varies greatly. The high tuning sensitivity of the coupling-tuning element having a metal rod is generally disadvantageous: First, after manufacturing of the resonators 21, the basic frequency characteristics of the filter 1 have been set, later tunings, in particular coupling-tunings, are only fine tunings rather than coarse tunings directed to manufacturing error and actual applications, and a high tuning sensitivity makes it more difficult to tune the filter and tends to lead to over-tuning or under-tuning; Second, the high tuning sensitivity raises higher requirements for the manufacturing precision of the filter 1, and once the manufacturing precision cannot meet requirements, the tuning performance may be greatly reduced.

In addition, the depth to which the metal rod may be inserted into the internal cavity 20 of the filter 1 is extremely limited. In the present embodiment, the extension range of the metal rod is limited to the second space 28, and the maximum extent to which the metal rod may be inserted into the cavity is 12 mm in an example embodiment. If the metal rod is inserted further into the cavity and, in particular, into the first space 27, at least two problems may arise. First, as the structure of the filter 1 is relatively compact and the interval between adjacent resonators 21 is small, when the metal rod and the resonator 21 get too close, an electric arc tends to be generated, which may seriously damage the filter 1. Second, if inserted too close to the resonators 21, the metal rod may also affect the frequency characteristics such as the resonant frequency point of the individual resonators 21 to thereby accomplish an opposite tuning effect.

In the case of using a coupling-tuning element 16 that includes a PEEK rod, the coupling coefficient initially increases as the PEEK rod is inserted and then decreases as the PEEK rod is inserted further into the internal cavity 20 of the filter 1. In the example of FIG. 5, when the PEEK rod is inserted to a depth of 12 mm it begins to enter the first space 27. As the dielectric constant of the PEEK rod is greater than the dielectric constant of air, when the PEEK rod enters the first space 27, the equivalent dielectric constant of the dielectric between the two adjacent resonators 21 becomes large, thereby affecting the coupling performance between the two adjacent resonators 21. As can be seen from FIG. 5, the PEEK rod has a smaller tuning sensitivity within the first space 27. In other words, the characteristic graph of the PEEK rod has a relatively flat slope, and each time the PEEK rod is inserted another unit length, the change in the coupling coefficient is relatively small. The application of the PEEK rod may bring a series of advantages: first, no electric arc is generated between a resonator 21 and the PEEK rod, and hence the PEEK rod may be inserted into the first space 27, thereby improving the reliability of the filter 1; second, the PEEK rod may not significantly affect the frequency characteristics such as the resonant frequency point of the individual resonators 21; third, in a compact space, the extendable length of the PEEK rod is significantly increased. As can be seen from FIG. 5, the maximum extent of the PEEK rod can reach 32 mm, which is almost three times that of the metal rod. Theoretically, the PEEK rod may extend from the second wall in the direction of extension of the PEEK rod up to the end of the first space 28, thereby widening the tunable range of the coupling-tuning element 16 and providing more tuning possibilities; fourth, the requirement for the manufacturing precision may be reduced and thus the manufacturing cost may be reduced (for example, in the case of employing the metal rod, the manufacturing tolerance may be required to be maintained at ±0.01 mm, while in the case of the PEEK rod, the manufacturing tolerance may be required to be maintained at ±0.1 mm).

It should be noted that the filter 1 may have any suitable configuration for acting as any type of filter (e.g., duplexer, diplexer, triplexer, band-stop, band-pass, low-pass, high-pass, etc.) and may have any appropriate design, and therefore is not limited to the configuration exemplarily described in the embodiments of the present invention. Any appropriate number of resonators may be included, and the design of the individual resonators may be changed. The resonators may or may not be aligned in a straight line, and may or may not have direct galvanic connections between adjacent and/or non-adjacent resonators. Likewise, in other embodiments, the filter 1 may have any N-sided configuration, such as a trilateral configuration, a quadrilateral configuration, a pentagonal configuration, a hexagonal configuration, and the like. In addition, the filter 1 may also have curved walls.

Likewise, the tuning elements may also have various configurations, not limited to the configuration exemplarily described in the embodiments of the present invention. In other embodiments, the coupling-tuning element 16 and/or the resonance-tuning element 30 may have any shape such as cylindrical, prismatic, pyramidal, stepped configuration, or the like.

In other embodiments, the resonators 21 may also extend from any portion of the housing toward another portion of the housing. For example, some or all of the resonators 21 may extend from the bottom wall (or the top wall) of the filter 1 towards the top wall (or bottom wall) of the filter 1. In this case, the resonance-tuning element 30 and the coupling-tuning element 16 may be disposed on the top wall (or bottom wall).

In other embodiments, a dielectric module may be mounted in the first space 27 instead of configuring the first space 27 as an air-filled space. The dielectric module may have a dielectric constant higher than that of air, and the dielectric module may include a tuning channel that may, for example, match the size of the rod of the coupling-tuning element 16. In this way, the coupling-tuning element 16 can extend into the tuning channel to tune the coupling characteristics between the two adjacent resonators 21.

Likewise, a dielectric module may also be mounted in the second space 28. The dielectric module may have a dielectric constant higher than that of air, and the dielectric module may include a tuning channel that may, for example, match the size of the resonance-tuning element 30. In this way, the resonance-tuning element 30 can extend into the tuning channel to tune the frequency characteristics of the corresponding resonators 21.

Although the specific embodiments of the present disclosure have been described in detail by way of example, those skilled in the art should understand that the above examples are for illustrative purposes only and are not intended to limit the scope of the present disclosure. The various embodiments disclosed herein may be combined in any combination without departing from the spirit and scope of the disclosure. It should also be understood by those skilled in the art that various modifications may be made in the embodiments without departing from the scope and spirit of the disclosure.

1. A filter, comprising:
a housing having a plurality of walls that define an internal cavity;
a plurality of resonators that are mounted within the internal cavity; and
a coupling-tuning element mounted on one of the walls of the housing,
wherein the coupling-tuning element comprises one or more solid dielectric materials and is configured to movably extend into a first space between a pair of adjacent resonators to tune the coupling characteristics between the pair of adjacent resonators.

2. The filter according to claim 1, further comprising a resonance-tuning element that is mounted on one of the walls of the housing and configured to tune the frequency characteristics of a first of the resonators.

3. The filter according to claim 1, wherein the first space includes:
a gap between the two resonators of the pair of adjacent resonators; and/or
a region above or below the gap; and/or
a region in front of or behind the gap.

4. The filter according to claim 1, wherein the coupling-tuning element includes a rod that is made of a polymeric compound or a ceramic.

5-7. (canceled)

8. The filter according to claim 1, wherein the coupling-tuning element includes a metal self-locking head that is configured to be secured within a mounting hole in one of the walls in a self-locking manner.

9. The filter according to claim 2, wherein a first of the resonators has a first end and a second end opposite thereto, the first end of the first of the resonators is electrically and mechanically connected to a first wall of the housing, and the first of the resonators extends from the first wall toward a second wall that is opposite the first wall, wherein a second space is present between an end surface of the second end of the first of the resonators and the second wall, and the resonance-tuning element is configured to movably extend into the second space.

10. The filter according to claim 1, wherein a dielectric module having a tuning channel is disposed in the first space, and the coupling-tuning element is configured to be movably inserted into the tuning channel.

11. The filter according to claim 9, wherein an extension range of the resonance-tuning element is less than a distance between the second wall and a plane where an end surface of the second end of the first of resonators is located.

12. The filter according to claim 9, wherein an extension range of the coupling-tuning element exceeds a distance between the second wall and a plane where an end surface of the second end of the first of the resonators is located.

13. The filter according to claim 9, wherein an extension range of the coupling-tuning element is greater than an extension range of the resonance-tuning element.

14-16. (canceled)

17. The filter according to claim 9, wherein at least one coupling segment is formed between two adjacent ones of the resonators.

18. The filter according to claim 1, wherein each resonator is equivalent to a quarter-wavelength open-ended transmission line, or equivalent to a half-wavelength open-ended transmission line.

19-21. (canceled)

22. A filter, comprising:
a housing defining an internal cavity;
a plurality of resonators mounted within the internal cavity,
wherein a first space is provided between two adjacent ones of the resonators, and a coupling-tuning element is configured so that it can movably extend into the first space to tune the coupling characteristics between the two adjacent ones of the resonators,
wherein the coupling-tuning element comprises one or more solid dielectric materials.

23. The filter according to claim 22, wherein a resonance-tuning element is further mounted in the filter so as to tune the frequency characteristics of a first of the resonators.

24-25. (canceled)

26. The filter according to claim 22, wherein the coupling-tuning element includes a rod that is made of polyetheretherketone.

27-29. (canceled)

30. The filter according to claim 23, wherein the first of the resonators has a first end and a second end opposite thereto, the first end of the first of resonators is electrically and mechanically connected to a first wall of the housing, and the second end of the first of the resonators is spaced apart from a second wall of the housing by a second space, wherein the resonance-tuning element is configured to movably extend into the second space.

31. The filter according to claim 22, wherein a dielectric module is disposed in the first space, a tuning channel is disposed in the dielectric module, and the coupling-tuning element is configured to movably extend into the tuning channel.

32. The filter according to claim 30, wherein an extension range of the resonance-tuning element is less than a distance between the second wall and a plane where an end surface of the second end of the first of the resonators is located.

33. The filter according to claim 32, wherein an extension range of the coupling-tuning element exceeds a distance between the second wall and a plane where an end surface of the second end of the first of the resonators is located.

34. The filter according to claim 30, wherein an extension range of the coupling-tuning element is greater than an extension range of the resonance-tuning element.

35-42. (canceled)
